(19) United States
(12) Patent Application Publication
(10) Pub. No.: US 2008/0250472 A1
(43) Pub. Date: Oct. 9, 2008

(54) INFORMATION PROCESSING SYSTEM, INFORMATION PROCESSING APPARATUS, INFORMATION PROCESSING METHOD AND COMPUTER READABLE MEDIUM

(75) Inventors: Kohei TANAKA, Ebina-shi (JP); Shinji OTA, Ebina-shi (JP); Toru HADA, Ebina-shi (JP); Masahiko HARADA, Ebina-shi (JP); Goro NODA, Ebina-shi (JP); Atsushi TAKESHITA, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/042,422

(22) Filed: Mar. 5, 2008

(30) Foreign Application Priority Data
Apr. 4, 2007 (JP) 2007-098413

(51) Int. Cl. G06F 21/00

(52) U.S. Cl. 726/1

(57) ABSTRACT

An information processing system includes: an information processing apparatus includes: an acceptance unit that accepts selection of a function and a start command of processing relating to the selected function; a determination unit that determines element processing executed to provide the selected function; and a request unit that makes an execution permission request of the element processing determined in association with the selected function before the start command of processing relating to the selected function is accepted; and a permission management apparatus that accepts the execution permission request of processing from the information processing apparatus, determines whether or not the execution is permitted, and informs the information processing apparatus of the determination result.

### CROSS-REFERENCE TO RELATED APPLICATIONS

This application is based on and claims priority under 35 U.S.C. 119 from Japanese Patent Application No. 2007-098413 filed Apr. 4, 2007.

### BACKGROUND

1. Technical Field

This invention relates to an information processing system, an information processing apparatus, an information processing method and a computer readable medium.

2. Related Art

There are various methods of imposing a license limitation on a program executed in a computer in various machines using a computer. As one mode of such a license, there is a method of limiting the number of execution times of a specific program module at one point in time in the whole of a large number of computers at a worksite where the computers connected to each other through a network operate, for example, as in an enterprise.

That is, when use of one program module at the same time is allowed in up to “five” computers in the whole of a large number of computers, if the number of computers executing the program module is four or less, the computer attempting to execute the program module can obtain the license to execute the program. However, if the number of computers executing the program module is five, the computer attempting to execute the program module cannot immediately obtain the license to execute the program and waits until any of the five computers terminates execution of the program module, and then gains the license.

In the license in the mode in which the number of computers that can execute the program module at the same time is limited for each program module as described above, when whether or not one program module will be executed is not determined at the point in time of execution start in user-selected processing, if an attempt is made to obtain the license when it becomes obvious that the program module is to be executed, the license may be unable to be obtained. As the license cannot be obtained, the selected processing is forced to be interrupted.

### SUMMARY

According to an aspect of the present invention, an information processing system including: an information processing apparatus includes: an acceptance unit that accepts selection of a function and a start command of processing relating to the selected function; a determination unit that determines element processing executed to provide the selected function; and a request unit that makes an execution permission request of the element processing determined in association with the selected function before the start command of processing relating to the selected function is accepted; and a permission management apparatus that accepts the execution permission request of processing from the information processing apparatus, determines whether or not the execution is permitted, and informs the information processing apparatus of the determination result.

### BRIEF DESCRIPTION OF THE DRAWINGS

Exemplary embodiment of the present invention will be described in detail based on the following figures, wherein:

FIG. 1 is a block diagram to represent the configuration of a system including an information processing apparatus according to an embodiment of the invention;

FIG. 2 is a functional block diagram to represent an example of the information processing apparatus according to the embodiment of the invention;

FIG. 3 is a schematic representation to represent an example of a screen displayed by the information processing apparatus according to the embodiment of the invention;

FIG. 4 is a schematic representation to represent a screen example of box operation displayed by the information processing apparatus according to the embodiment of the invention;

FIG. 5 is a schematic representation to represent a list display example of image information displayed by the information processing apparatus according to the embodiment of the invention;

FIG. 6 is a schematic representation to represent an example of an output setting screen displayed by the information processing apparatus according to the embodiment of the invention;

FIG. 7 is a schematic representation to represent an example of an option selection screen displayed by the information processing apparatus according to the embodiment of the invention; and

FIG. 8 is a schematic representation to represent a content example of an element processing database retained in the information processing apparatus according to the embodiment of the invention.

### DETAILED DESCRIPTION

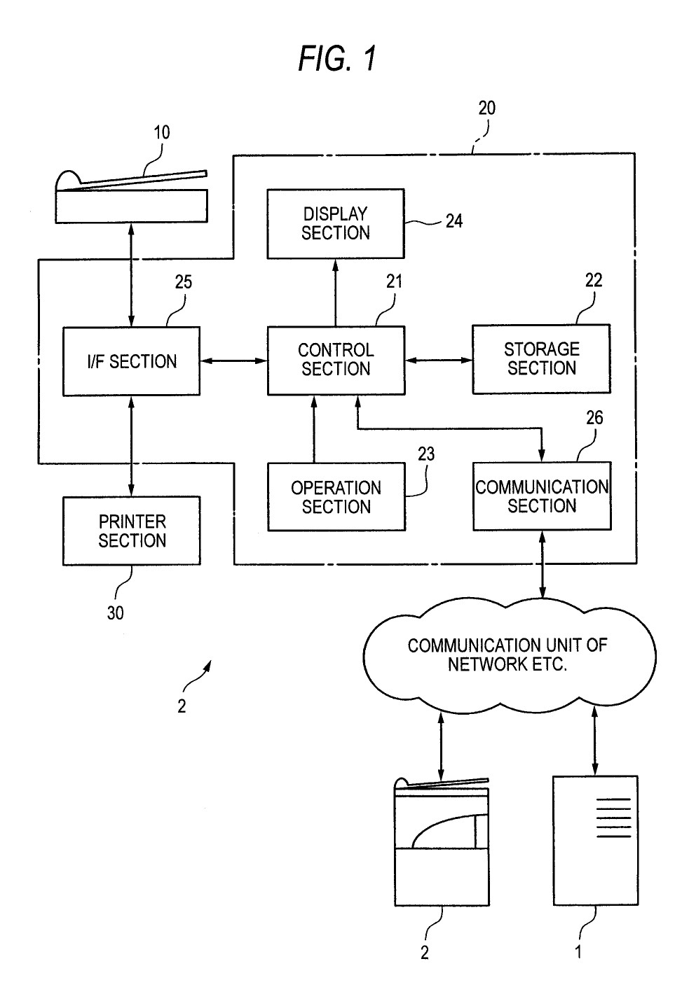

Referring now to the accompanying drawings, there is shown an embodiment of the invention. An information processing apparatus according to the embodiment is implemented as a multiple function processing machine 2, for example. This multiple function processing machine 2 provides the functions of a plurality of units such as a copier, a scanner, and a printer as multiple functions; at least one is connected to a server 1 as a permission management apparatus through communication unit of a network, etc., as illustrated in FIG. 1.

The server 1 as the permission management apparatus retains information for determining a program module and information of an execution permission condition in association with each other. The server 1 accepts the information for determining a program module and a request for execution permission of the program module determined by the information from the multiple function processing machine 2. The server 1 acquires the execution permission condition associated with the program module involved in the accepted request (program module to which execution permission is applied).

The server 1 determines whether or not the acquired condition is satisfied and if the acquired condition is satisfied, the server 1 permits the multiple function processing machine 2 of the requester to execute the program module involved in the request. Execution can be permitted, for example, by previously encrypting information required for execution of the program module and issuing a decipher key (license key) to decrypt the encrypted information.

Here, the execution permission condition may be that the number of multiple function processing machines 2 granted the execution permission of the program module be N or less (namely, floating license type in which the party granted the execution permission is not specified). In this case, a counter for representing the number of multiple function processing machines 2 granted the execution permission is stored for each program module. The server 1 increments by one the counter about the program module to which the license key is issued. In this case, if the license key becomes unnecessary, the multiple function processing machine 2 performs return processing of the license key. For example, the multiple function processing machine 2 informs the server 1 that the license key becomes unnecessary, and deletes the license key. At this time, the server 1 decrements by one the counter about the program module corresponding to the license key to which the return processing is applied.

That is, the license key corresponds to the processing execution right of N machines; in the embodiment, each multiple function processing machine 2 temporarily borrows and occupies the execution right and returns it after completion of execution of the program module.

When the server 1 determines whether or not the execution permission condition associated with the program module involved in the request is satisfied, the server 1 makes a comparison between the maximum number of machines N preset about the program module involved in the request and value n of the counter about the program module involved in the request and if N≧n, the server 1 issues the license key.

Various systems for realizing such as a floating license are widely known and in the embodiment, any system may be used.

The multiple function processing machine 2 is made up of a scanner section 10, a controller section 20, and a printer section 30 as shown in FIG. 1, and the controller section 20 is made up of a control section 21, a storage section 22, an operation section 23, a display section 24, an interface (I/F) section 25, and a communication section 26.

The scanner section 10 is, for example, a flat bed scanner, and optically reads an image of an original placed on the read plane and outputs the image information to the controller section 20.

The control section 21 of the controller section 20 is a program control device of a CPU (Central Processing Unit), etc., and operates in accordance with a program stored in the storage section 22. The program may be provided as it is stored on a DVD-ROM, streamer tape, or any other computer-readable medium according to a physical or chemical method (electromagnetic, optical, etc.), and may be copied into the storage section 22.

In the embodiment, the control section 21 accepts selection of the function to be provided, such as copy or image formation, from the user through the operation section 23. The control section 21 determines at least one element processing having a possibility of being executed to provide the selected function, and requests the server 1 to grant permission of execution of the determined element processing. The control section 21 gains the requested element processing execution permission from the server land starts providing the selected function. The specific processing of the control section 21 is described later in detail.

The storage section 22 contains storage elements of RAM (Random Access Memory), ROM (Read-Only Memory), etc. A program executed by the control section 21 is stored in the storage section 22. The storage section 22 also operates as work memory of the control section 21.

The operation section 23, which is a keypad, a touch panel, etc., accepts operation of the user and outputs the description of the operation to the control section 21. The display section 24 is a liquid crystal display panel, etc., for displaying information in accordance with the command input from the control section 21. The display section 24 may be installed so that it can be visually recognized through the transparent electrode of the touch panel.

The I/F section 25 is an interface unit and is connected to the scanner section 10 and the printer section 30. It outputs information to the scanner section 10 and the printer section 30 in accordance with the command input from the control section 21. The I/F section 25 outputs image information output by the scanner section 10 to the control section 21.

The communication section 26 is, for example, a network interface and transfers information to and from an external machine such as the server 1 through communication unit of a network, etc. It transmits information to the destination specified by the control section 21 in accordance with the command input from the control section 21. The communication section 26 receives information coming through the communication unit and outputs the information to the control section 21.

The printer section 30 is a laser printer, etc., for forming an image on a print medium of paper, etc. based on image information output by the controller section 20.

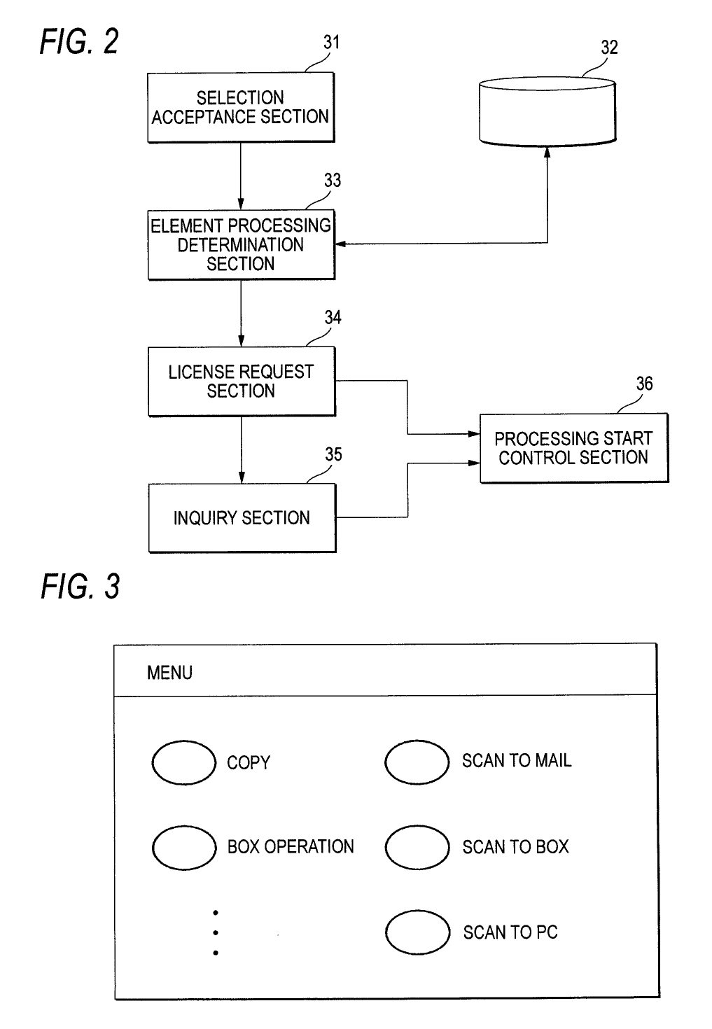

Here, the specific processing of the control section 21 will be discussed. The control section 21 executes the program stored in the storage section 22, whereby the multiple function processing machine 2 of the embodiment becomes a machine functionally made up of a selection acceptance section 31, an element processing database 32, an element processing determination section 33, a license request section 34, an inquiry section 35, and a processing start control section 36, as shown in FIG. 2.

The selection acceptance section 31 displays a list of functions on the display section 24 and requests the user to select one of the functions. That is, the selection acceptance section 31 accepts selection of the user through the operation section 23. In the multiple function processing machine 2 of the embodiment, the user is requested to select any function to be provided through levels. As a specific example, first, buttons for calling functions such as copy, scan (a button for transmitting the scan result to another computer and a button for box retention to store the scan result in the storage section 22), and “box operation” for selecting information stored in the storage section 22 as a processing target and transmitting the information to another computer or printing the information are displayed as illustrated in FIG. 3.

When the user performs operation of selecting any of the functions, a screen for requesting the user to make further detailed settings of the function is displayed and information about the function to be provided is accepted from the user.

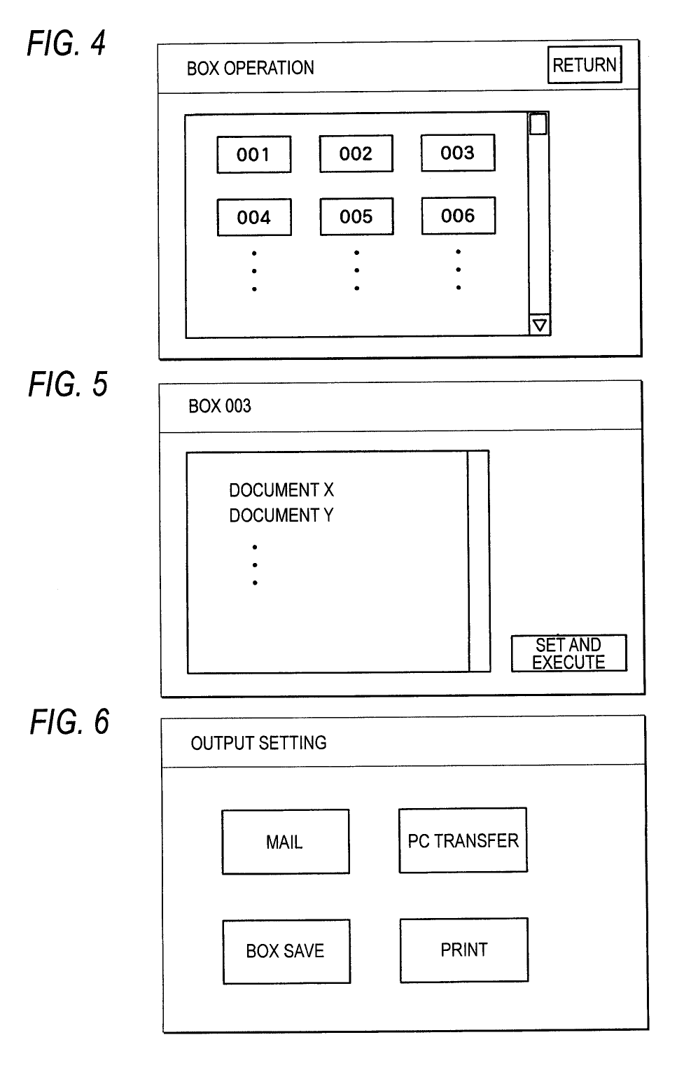

By way of example, if the user selects “box operation” out of the screen illustrated in FIG. 3, the selection acceptance section 31 requests the user to select image information to which the following processing is applied from among information pieces stored in the storage section 22. If the storage section 22 adopts a hierarchical directory structure, first, a screen for requesting the user to select a high-level directory (called “box”) is provided as illustrated in FIG. 4. When the selection acceptance section 31 accepts selection operation on the screen, it displays a list of image information stored in the selected box (directory) (FIG. 5).

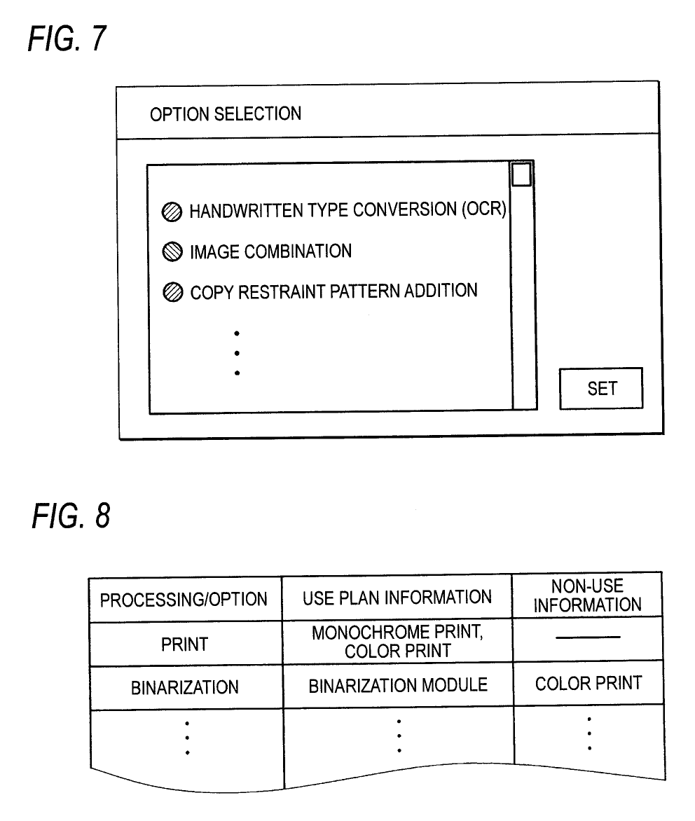

When the user selects the target image information out of the list and presses a “set, execute” button, the selection acceptance section 31 displays a screen for accepting selection of processing about the image information (FIG. 6). In FIG. 6, menu items of “mail transmission,” “transfer to computer,” “save,” “print,” etc., are arranged. Further, if the user presses “print,” the selection acceptance section 31 provides a screen for requesting the user to select an option that can be specified in connection with print processing (function to be provided subsidiarily) (FIG. 7). In the description of the embodiment to follow, it is assumed that there are functions to be provided subsidiarily and the functions are installed as independent program modules (processing elements). It is assumed that floating license management is conducted for each program module.

To further display the options that can be specified in connection with the selected processing as shown in FIG. 7, the selection acceptance section 31 inquires of the server 1 whether or not the license of the program module corresponding to each option can be granted at the point in time of display.

In response to the inquiry, the server 1 determines whether or not the license of the program module involved in the inquiry can be provided. To make the determination, a comparison may be made between the maximum number of machines N preset as licensable about the program module involved in the inquiry and the value n of the counter about the program module and if N≦n, it may be determined that the license of the program module can be granted. The server 1 transmits the result of the determination to the multiple function processing machine 2.

The multiple function processing machine 2 displays the options using the program module determined a program module whose license can be granted and the options using the program module not determined a program module whose license can be granted in a mode in which they can be distinguished from each other in response to the determination result of the server 1 relating to the inquiry. As the mode in which they can be distinguished from each other, for example, the character strings of the option names may be displayed in different colors or may be displayed in different styles of blinking, italic, etc. In the example in FIG. 7, a mark (X) representing whether or not license can be granted is displayed like a signal in association with the character string of the option name. For example, the option with the mark “blue” is visually recognized as the option using the program module whose license can be granted at the point in time of display and the option with the mark “red” is visually recognized as the option using the program module whose license cannot immediately be granted at the point in time of display. Here, the option is represented by a character string, but may be represented by an icon, etc.

The selection acceptance section 31 outputs information for determining the option selected by the user, information for determining the image processing to be executed (“mail transmission,” “transfer to computer,” “save,” or “print,” etc.), and information for determining the image information to be processed.

The element processing database 32 is a database associating information for determining the program module having a possibility of being used (use plan information: B) with option information or processing determination information (A), as shown in FIG. 8. In the embodiment, further, with the option information or processing determination information (A), information for determining the program module whose use possibility is eliminated if each is selected (non-use information: C) is associated for storage. For example, as the use plan information, information for determining the program module of “monochrome print,” “color print,” etc., is associated with “print” processing. As the program module whose use possibility is eliminated (non-use information), information for determining the program module of “color print” is associated with the option of “conversion to gray scale,” etc.

The element processing determination section 33 performs processing of determining at least one element processing having a possibility of being executed using a plurality of functions in combination. That is, the element processing determination section 33 receives the information output by the selection acceptance section 31 and extracts at least information for determining the option selected by the user and information for determining the image processing to be executed. Then, the element processing determination section 33 acquires the use plan information and the non-use information stored in the element processing database 32 in association with the extracted information.

The element processing determination section 33 generates a disjunction set of sets of information for determining the program modules contained in the acquired use plan information. It generates a set in which information for determining the program modules contained in the acquired non-use information is removed from that generated set. Taking the case where processing of “print” and options of “binarization” and “type replacement using OCR (optical character recognition)” are selected as an example, the operation of the element processing determination section 33 is as follows:

First, for example, “monochrome print” and “color print” are acquired as the use plan information about the processing of “print.” “Binarization module” is acquired as the use plan information of the “binarization” option and likewise “color print” is acquired as the non-use information of the “binarization” option. Further, it is assumed that for the “type replacement using OCR (optical character recognition)” option, for example, “binarization module,” “OCR (optical character recognition) module,” and “type replacement module” are acquired as the use plan information.

The element processing determination section 33 obtains a union of the program modules acquired as the use plan information. That is, here, a set containing “monochrome print,” “color print,” “binarization module,” “OCR (optical character recognition) module,” and “type replacement module” is generated. Further, the element processing determination section 33 removes information of the program module acquired as the non-use information from the union. Here, “color print” is acquired as the non-use information and thus is removed and after all, a set containing “monochrome print,” “binarization module,” “OCR (optical character recognition) module,” and “type replacement module” is obtained.

The element processing determination section 33 outputs information for determining the program modules contained in the finally obtained set.

The license request section 34 transmits a request for execution permission about the program modules determined by the information output by the element processing determination section 33 to the server 1 regardless of whether or not the user enters an execution start command. That is, in the embodiment, a license request is started before the user enters an execution start command. If execution permission (license key) cannot be obtained about at least one of the program modules involved in the execution permission request, the license request section 34 outputs information representing the fact to the inquiry section 35. It continues the execution permission request processing about the program module whose execution permission cannot be obtained.

The license request section 34 may output the result of the execution permission request to the display section 24.

Upon acceptance of the information to the effect that execution permission cannot be obtained from the license request section 34, the inquiry section 35 displays a screen indicating the fact that there is a program module whose license key is rejected and inquiring of the user whether or not processing is to be started. In this screen, a list of the program modules whose execution permission cannot be obtained may be displayed together. When the user enters an execution start command, the inquiry section 35 outputs the entered command to the processing start control section 36.

Upon reception of the execution start command from the inquiry section 35, the processing start control section 36 checks whether or not execution permission of all program modules involved in the request sent from the license request section 34 to the server 1 is obtained. If execution permission of all program modules involved in the request is obtained, the processing start control section 36 starts processing for providing the function selected by the user. The started processing is, for example, binarization, OCR processing, print processing of a character string based on the result, etc., and is widely known and therefore will not be discussed in detail.

If execution permission is not obtained about at least one of the program modules involved in the request sent from the license request section 34 to the server 1 and information representing the fact that the user enters an execution start command is input from the inquiry section 35, the processing start control section 36 starts processing for providing the function selected by the user.

If execution permission is not obtained about at least one of the program modules involved in the request sent from the license request section 34 to the server 1 and information representing the fact that the user enters a processing wait command is input from the inquiry section 35, the processing start control section 36 waits until execution permission of all program modules involved in the request sent from the license request section 34 to the server 1 is obtained.

As described above, in the embodiment, the user of the multiple function processing machine 2 of the information processing apparatus operates the multiple function processing machine 2 to select the function to be provided by the multiple function processing machine 2, such as print of image information stored in the multiple function processing machine 2. The multiple function processing machine 2 determines at least one element processing having a possibility of being executed to provide the selected function and requests the server 1 to permit execution of the determined element processing.

Upon reception of the request for permitting execution of the determined element processing, the server 1 determines whether or not execution of the processing element involved in the request can be permitted. The server 1 transmits the license key for the request involving the processing element whose execution is permitted, and transmits information to the effect that execution cannot be permitted for the request involving the processing element whose execution is not permitted.

The multiple function processing machine 2 obtains the license key or the information to the effect that execution cannot be permitted for each processing element. If the license key is received about all requested processing elements or when the user enters an execution start command, the multiple function processing machine 2 starts processing for providing the selected function.

Upon completion of the processing for providing the function, the multiple function processing machine 2 performs processing of returning (invalidating) the license key granted about the function.

When performing the processing sequence for providing the function, to use the program module at each processing step, the multiple function processing machine 2 may perform return processing of the license key of the program module completing the processing each time the processing of the program module is complete (even if the whole of the processing sequence is not complete).

Therefore, in the embodiment, execution permission of a processing element having a possibility of being used is previously requested, so that interruption of providing the function because execution permission cannot be granted during the processing is eliminated.

In the description given so far, the above-described processing may be executed only when the printer section 30 is used according to the function selected by the user, and the license key may be acquired in a similar manner to that in the related art when the printer section 30 is not used.

If there is a program module whose execution possibility occurs as an option is selected and which requires acquisition of the license key, when the option is selected, a license key request may be sent to the server 1. This request may be made even if the license key cannot be provided according to the result of inquiring the server 1 when a list of options is displayed. Thus, when it is determined that there is a possibility that the license key cannot be provided in displaying a list of options, if a license key request is sent to the server 1, if the license key can be obtained in response to the request, information to the effect that the license key can be acquired is displayed in the option list display. For example, if a mark (X) representing whether or not license can be granted is displayed like a signal in association with the character string of the option name as illustrated in FIG. 7, when the mark is “red” indicating use of the program module whose license cannot immediately be granted at the point in time of display, the mark is displayed in “blue” indicating that the license can be granted if the license key can be obtained by the request sent to the server 1.

The embodiment has been described by assuming that the user selects the processing or option to be executed for each function to be provided, but the embodiment is not limited to the mode. For example, if there is a set of often selected functions or often specified options, a processing set or a set of options to be executed according to that set may be previously registered together with a name or an identifier and the user may call it, whereby the processing or option set may be set.

If the user cancels function selection (if the user changes the function to be provided, such as cancel of execution or function selection cancel) before the user enters an execution start command, the multiple function processing machine 2 may perform return processing of the license key about the function whose selection is canceled at the point in time (if execution is canceled, all selected functions).

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing system comprising:
an information processing apparatus includes:
an acceptance unit that accepts selection of a function and a start command of processing relating to the selected function;
a determination unit that determines element processing executed to provide the selected function; and
a request unit that makes an execution permission request of the element processing determined in association with the selected function before the start command of processing relating to the selected function is accepted; and
a permission management apparatus that accepts the execution permission request of processing from the information processing apparatus, determines whether or not the execution is permitted, and informs the information processing apparatus of the determination result.

2. An information processing apparatus comprising:
an acceptance unit that accepts selection of a function and a start command of processing relating to the selected function;
a determination unit that determines element processing executed to provide the selected function; and
a request unit that makes an execution permission request of the determined element processing, and that makes the execution permission request of the element processing relating to the selected function before the start command of processing relating to the selected function is accepted.

3. The information processing apparatus as claimed in claim 2,
wherein
the acceptance unit accepts a command for providing a plurality of functions, and
the determination unit determines element processing to be executed using the plurality of functions in combination.

4. The information processing apparatus as claimed in claim 2, further comprising:
a display unit that displays a message to the effect that permission is granted in a case where the execution permission is granted.

5. The information processing apparatus as claimed in claim 2, further comprising:
a display unit that displays the result of the request made by the request unit.

6. The information processing apparatus as claimed in claim 2, wherein the acceptance unit accepts a start command of processing relating to the function in a case where the execution permission is not granted.

7. An information processing apparatus comprising:
a selection acceptance unit that accepts selection of a command to be provided;
an instruction acceptance unit that accepts an execution start command of the selected function; and
an acquirement unit that acquires permission concerning processing of the selected function from a management apparatus determining whether or not the processing is to be permitted before a start command of processing relating to the selected function is accepted.

8. The information processing apparatus as claimed in claim 7, further comprising:
a return unit that returns the acquired permission to the management apparatus in a case where the function selected by the selection acceptance unit is canceled.

9. The information processing apparatus as claimed in claim 7, further comprising:
a return unit that returns the permission relating to each processing to the management apparatus whenever each processing terminates as the processing relating to the function is executed in sequence upon reception of the execution start command.

10. An information processing method comprising:
accepting selection of a function and a start command of processing relating to the selected function;
determining element processing executed to provide the selected function; and
making an execution permission request of the element processing determined in association with the selected function before the start command of processing relating to the selected function is accepted.

11. A computer readable medium storing a program causing a computer to execute a process for performing an information processing, the process comprising:
accepting selection of a function and a start command of processing relating to the selected function;
determining element processing executed to provide the selected function; and
making an execution permission request of the element processing determined in association with the selected function before the start command of processing relating to the selected function is accepted.
